(19) United States
(12) Patent Application Publication
(10) Pub. No.: US 2004/0198387 A1
(43) Pub. Date: Oct. 7, 2004

(54) Position detection system and portable terminal

(76) Inventors: Naoki Tsuji, Hitachinaka (JP); Yoshiaki Umehara, Hitachiota (JP); Fumiharu Nakahara, Hitachinaka (JP); Yoshitaka Imakado, Hitachinaka (JP)

Correspondence Address: MCDERMOTT WILL & EMERY LLP, 600 13TH STREET, N.W., WASHINGTON, DC, 20005-3096, US

(21) Appl. No.: 10/338,883

(22) Filed: Jan. 9, 2003

(30) Foreign Application Priority Data
May 21, 2002 (JP) 2002-146384

(51) Int. Cl. G01S 1/00

(52) U.S. Cl. 455/456.1; 342/357.06

(57) ABSTRACT

A position detection system and a portable terminal are disclosed. The portable terminal carries out communication with a server in the first position detection session and thereby acquires the GPS assist information and the base station position information from the server. Using the GPS assist information thus acquired, the portable terminal transmits the GPS signal received from a GPS satellite to the server, and receives the position information of the portable terminal calculated by the server. In the second and subsequent sessions of position detection, the portable terminal neither establishes communication with the server nor receives the GPS signal, but makes calculations for position detection on its own using the result of measuring the radio wave propagation time from nearby base stations, the position information of the portable terminal obtained in the preceding session and the base station position information.

### BACKGROUND OF THE INVENTION

The present invention relates to a technique for detecting the position of a portable terminal such as a portable telephone of CDMA (Code Division Multiple Access) type.

As a first method of measuring the position of a mobile station for radio communication, a method has been proposed for measuring and calculating the distances from a plurality of base stations at specified positions. Typical methods of measurement include a technique in which a party that has received a transmitted radio wave measures and uses the strength of the electric field and a technique for measuring the propagation time before receiving a transmitted radio wave.

In a portable telephone, the strength of an electric field is required to be measured by the receiving party in order to secure a predetermined strength of the electric field in executing the transmission and receiving operation. For this reason, the former method is easy to employ at the sacrifice of a low accuracy.

An example of the latter method is disclosed in JP-A-7-181242. The use of this method in the suburbs having small numbers of obstacles to the propagation of the radio wave, however, reduces the number of basic stations capable of receiving the radio wave at the same time to three or less due to a sparse arrangement of base stations, and therefore the position cannot be sufficiently measured. In urban areas with a dense arrangement of base stations, on the other hand, though the radio wave can be received by about six stations at the same time, the effect of the radio waves reflected on buildings and other obstacles is considerable. These obstacles make inaccurate position measurement using base stations alone. Therefore, a method of position measurement with high accuracy is desired.

In a second method of determining the position of a mobile unit, the mobile unit receives signals from a plurality of artificial satellites and calculates the position of the mobile unit based on the information obtained by calculating the positions of the satellites at the time of measurement. In this method, a high accuracy is secured by the use of GPS (Global Positioning System) satellites located at higher than a certain angle from the earth surface. The position measurement system of GPS type basically eliminates the need of a ground system, and the high accuracy thereof has promoted applications to portable equipments (portable terminals). Nevertheless, the GPS system requires a long time for initialization and therefore has not been readily applicable to the portable telephone, in which power saving is crucial and the circuit power is frequently switched off.

As a method for solving this problem, a technique has been developed in which the initialization can be carried out within a short time by providing information on GPS satellites from a base station. An example of this technique has been disclosed in JP-A-11-513787. According to the technique disclosed in this publication, a server constantly observes GPS satellites and, in synchronism with the synchronous timing of the signals received from the GPS satellites, transmits GPS assist information to a terminal unit. The GPS assist information contains the number of the GPS satellites of which signals can be received by a terminal unit and the range of the synchronous timing for receiving the signals of each GPS satellite. A terminal unit having the GPS communication function built therein, on the other hand, searches the signals transmitted from the GPS satellites using the GPS assist information, reports the GPS information thus acquired to a server, and receives the result of the calculations for position detection from the server thereby to acquire the position.

In the position detection service using the position detection system described in the above-mentioned publication, a terminal unit, upon receipt of a request for position detection from the user, measures (initial pilot phase measurement) the radio wave propagation time of the signal received from the nearby CDMA base stations, and reports the result of the measurement to the server. The server performs the calculations for detecting the approximate position of the terminal unit using the measurement result reported and the data base of the base stations held by the server. The server then transmits to the terminal unit the GPS assist information on the GPS satellites supposed to be capable of being acquired at the particular approximate position of the terminal unit.

The terminal unit attempts to catch a GPS satellite based on the GPS assist information received. The terminal unit reports to the server the result of measurement (pseudo range measurement) of the radio wave propagation time of the signals from the GPS satellites that could be acquired and the result of the measurement (second pilot phase measurement) of the radio propagation time of the signals received from nearby CDMA base stations. Based on the two measurement results thus received, the server makes calculations for detecting the position of the terminal unit, and supplies the user with the position information by transmitting the calculation result to the terminal unit.

In the case where the GPS satellites in the number (four or more) required for calculation to determine the position cannot be acquired, the position can be detected by making calculations for position detection using the CDMA base stations in the same manner as if GPS satellites are used.

The conventional portable telephone capable of GPS measurement, because of using a common circuit switched between the GPS and the portable telephone, cannot be used for speech during the position measurement.

### SUMMARY OF THE INVENTION

In the position detection using the GPS measurement described above, the calculations for detecting the position of a terminal unit are made not by the terminal unit but by a server who has received the result of the pseudo range measurement and the second pilot phase measurement from the terminal unit. The communication with the server is required for each session of position detection, during which the communication charge accrues. Therefore, this system cannot be operated conveniently for the user who wants to be kept informed of the route of movement thereof.

Also, in this position detection system, each time the terminal unit requests the server for position detection, it receives the GPS assist information from the server and, receiving a GPS signal based on the GPS assist information, performs the pseudo range measurement. The server that has received the result of the pseudo range measurement and the second pilot phase measurement makes the calculations for position detection and transmits the position information together with the map information to the terminal unit. As a result, the problem is posed that a long time is consumed before the terminal unit acquires the position information after issuing a request for position detection. Depending on the algorithm for the position calculation by the server and the data transmission rate, it may take as long as about 20 seconds before the acquisition of the position information after operating the terminal unit.

Even in the case where the terminal unit is equipped with means of calculations for position detection, the terminal unit in the position detection system described above is incapable of position detection for lack of necessary and sufficient information for the calculations.

The object of the present invention is to make it possible to acquire the position information continuously while suppressing the charge required for acquisition of the position information, to shorten the time required for position detection and to make it possible to acquire the position information during speech.

In order to achieve the above-mentioned object, according to this invention, there is provided a position detection system comprising at least a portable terminal capable of receiving a GPS signal from at least a GPS satellite, at least a base station for conducting communication with the portable terminal, and a server for receiving the GPS signal from the portable terminal through the base station and detecting the position of the portable terminal. In the initial session of position detection, the portable terminal establishes communication with the server, and acquires the GPS assist information and the base station position information from the server. Using the GPS assist information thus acquired, the portable terminal transmits the GPS signal received from the GPS satellite to the server, and receives the position information of the portable terminal calculated by the server. In the second and subsequent sessions of position detection, the terminal unit neither establishes communication with the server nor receives the GPS signal, but make calculations by itself for position detection using the result of measurement of the radio wave propagation time from a nearby base station, the preceding position information of the portable terminal and the base station position information.

Other objects, features and advantages of the invention will become apparent from the following description of the embodiments of the invention taken in conjunction with the accompanying drawings.

### BRIEF DESCRIPTION OF THE DRAWINGS

FIG. 1 is a flowchart showing the flow of the process for position measurement operation of a portable telephone according to a first embodiment of the invention.

FIG. 2 is a block diagram showing a configuration of a portable telephone according to the first embodiment of the invention.

FIG. 3 is a timing chart for explaining the measurement of the time shift of a synchronizing signal.

FIG. 4 is a flowchart showing the process for the position measurement operation of a portable telephone according to a second embodiment of the invention.

FIG. 5 is a block diagram showing a configuration of a portable telephone according to a second embodiment of the invention.

FIG. 6 is a diagram for explaining a general configuration of a position measurement system for a portable telephone using a GPS satellite.

FIG. 7 is a diagram for explaining the synchronization time shift between a base station and a portable telephone.

### DETAILED DESCRIPTION OF THE INVENTION

Embodiments of the invention will be explained below with reference to the drawings.

In the embodiments described below, an example is taken of a case involving four or more GPS satellites capable of being acquired and four or more communicable CDMA base stations. Nevertheless, the invention is not confined to this case but is applicable also to a case involving less than four CDMA base stations.

A server constantly receives a GPS signal from the GPS satellites and transmits the GPS assist information and the base station information of the CDMA base stations through a switching system in synchronism with the synchronization timing of the GPS signal from the CDMA base stations. The CDMA base station information contains the latitude, longitude, altitude, Base ID, NID and the PN offset value of a transmitted pilot signal of each base station. The Base ID is an identifier of a base station, and NID an identifier of the network associated with the particular base station. The network of the system ID (SID) includes networks each having a network ID (NID), and each network includes a CDMA base station.

In the embodiments described below, a portable terminal is a radio telephone (hereinafter referred to as the portable telephone) of CDMA type having the GPS communication function built therein. The portable telephone includes memory means for storing the CDMA base station information, etc., and calculation means for making calculations for position detection. The CDMA (Code Division Multiple Access) as referred herein includes the code division multiple access systems employed for the 2.5- and third-generation portable telephone such as cdmaOne, cdma2000, W-CDMA (Wideband Code Division Multiple Access).

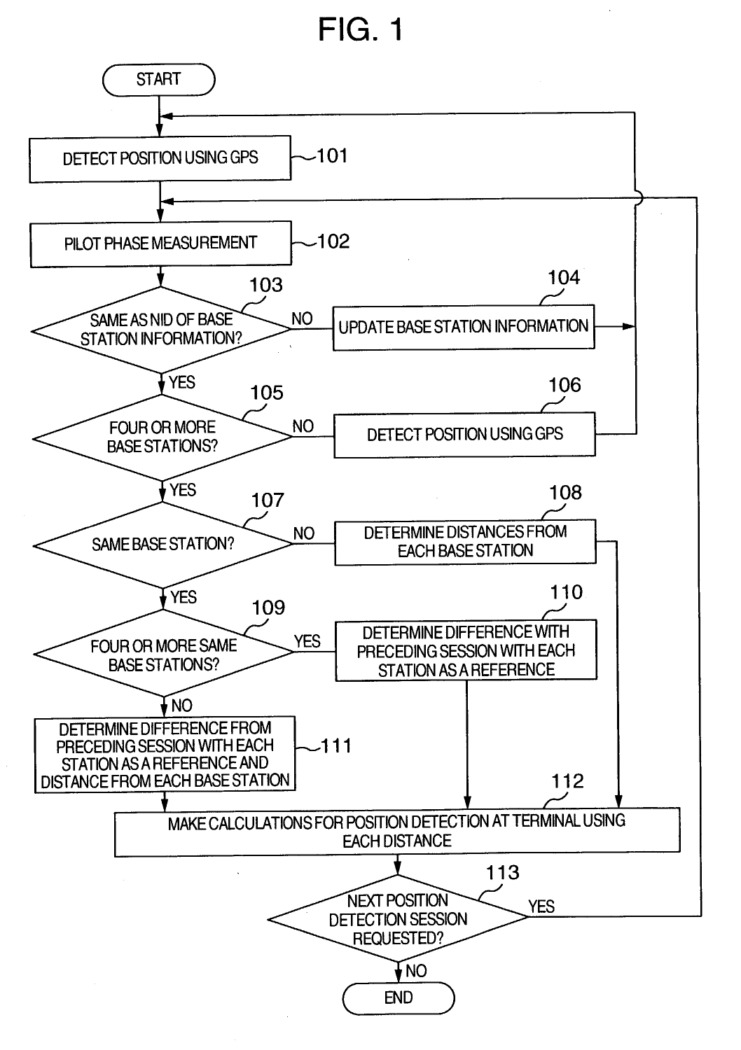

A first embodiment of the invention will be explained with reference to FIGS. 1 to 3, 6 and 7. This embodiment and the second embodiment described later presuppose the CDMA system in which the signal of high-precision clock system employed by the GPS satellite is received and used as a time reference.

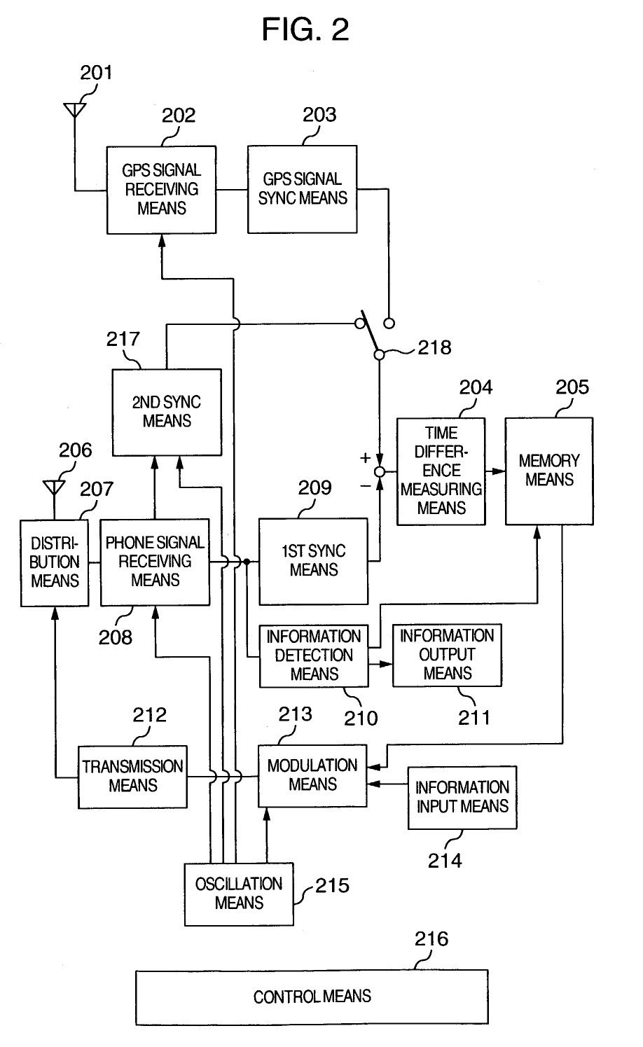

FIG. 2 is a block diagram showing a configuration of a portable telephone 12 according to this embodiment. The portable telephone 12 having the GPS communication function built therein includes a memory means 205, an information output means 211, an information input means 214, an oscillation means 215, a control means 216 and a changeover switch 218. The portable telephone 12 further includes component elements for processing the GPS signal, such as a GPS antenna 201, a GPS signal receiving means 202, a GPS signal synchronization means 203 and a time difference detection means 204 on the one hand, and component elements of the portable telephone proper such as a telephone antenna 206, a transmission/receiving distribution means 207, a telephone signal receiving means 208, a first synchronization means 209, an information detection means 210, a transmission means 212 for transmitting a telephone signal, a modulation means 213 for modulating the telephone signal and a second synchronization means 217.

The information output means 211 includes a liquid crystal display, a speaker, a vibrator for informing of incoming call, and so on. The information input means 214 includes a key switch, a microphone, a compact video camera, and so on.

The control means 216 is connected, though not shown in FIG. 2, to substantially all the means except for the antennae 201 and 206. The control means 216 is adapted to receive signals from each means and control the operation of each means with the signals thus received. The oscillation means 215 supplies each means with a periodic signal of the frequency required of the particular means.

The GPS signal receiving means 202 and the telephone signal receiving means 208 are supplied respectively with a periodic signal for heterodyne detection from the oscillation means 215. Based on the control operation of the control means 216, the GPS signal receiving means 202 outputs a GPS signal upon receipt of the GPS signal, and the telephone signal receiving means 208 outputs a telephone signal upon receipt of the telephone signal.

The first synchronization means 209 receives the telephone signal output from the telephone signal receiving means 208, and in synchronism with the pilot signal of selected one of communicable base stations, maintains the synchronism until the end of the communication. The pilot signal is based on the high-precision time reference of the base stations and is transmitted from each base station (CDMA base station). This signal is searched for by the portable terminal 12 first of all when it communicates with a base station. The second synchronization means 217, which has the same function as the first synchronization means 209, is used for establishing communication with two base stations at the same time in the case where the portable telephone 12 crosses the boundary between the two base stations.

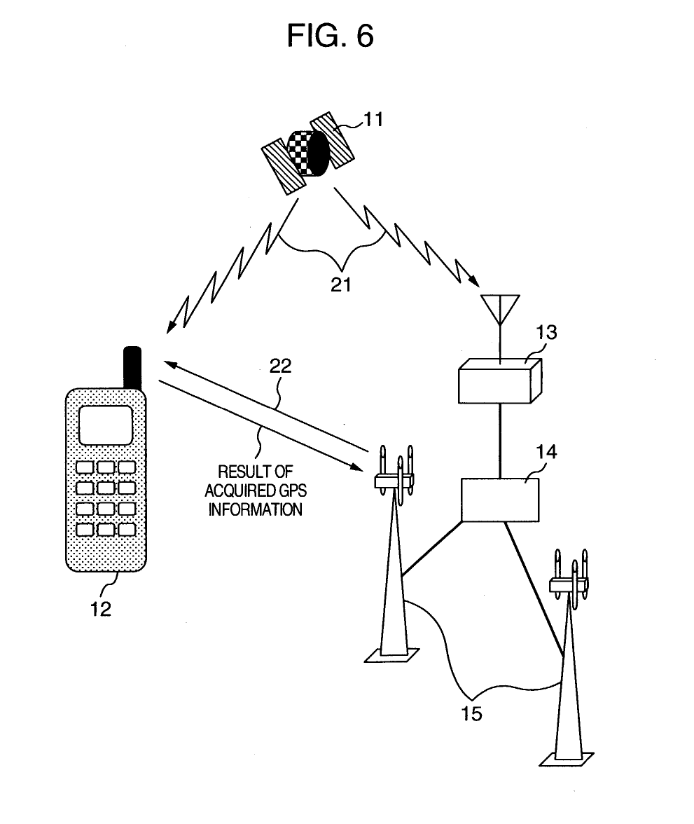

The general operation of position detection will be explained with reference to FIG. 6, which shows one GPS satellite 11 and two CDMA base stations 15 representing the system. In FIG. 6, reference numeral 13 designates a server (GPS server) and numeral 14 a switching system.

The portable telephone 12, upon receipt of a position measurement start command, establishes a communication route with the server 13 constituting a reference GPS receiver and requests the server 13 to start the position measurement. At the same time, the portable telephone 12 measures the propagation time of the radio waves capable of being received from the nearby base stations 15 (initial pilot phase measurement), and reports the measurement result to the server 13. The radio wave propagation time is the time required before a radio wave from a base station reaches the portable telephone 12.

The result of the pilot phase measurement contains the information (Base ID, SID, NID, PN, Ec/Io) on the base station (Serving BS) in communication and the information (PN, Ec/Io) on communicable nearby base stations. The symbol PN designates a pseudo-random code shared by the base stations and transmitted from each base station with a unique time shift thereto. The symbol Ec/Io designates the strength, as of the time of signal receipt, of the radio wave of the signal transmitted by each base station and received by the portable telephone, as expressed by energy ratio.

The server 13 making up a reference GPS receiver for constantly receiving the GPS signal 21 from the GPS satellite 11 calculates the approximate position of the portable telephone 12 based on the result of the initial pilot phase measurement. The server 13 transmits the GPS assist information 22 on the signal of the GPS satellite 11 capable of being received by the portable telephone 12, toward the portable telephone 12 through the switching system 14 and the base stations 15. The GPS assist information 22 contains the timing information required for the portable telephone 12 to synchronize the signals from a plurality of the GPS satellites 11 which can be received.

The portable telephone 12 establishes synchronization of each GPS signal 21 using the GPS assist information 22 received. The portable telephone 12 measures the propagation time of the radio wave of the GPS signal 21 (pseudo range measurement) while at the same time measuring the propagation time of the radio wave from the nearby base stations 15 (second pilot phase measurement). The portable telephone 12 reports the result of the pseudo range measurement and the pilot phase measurement to the server 13 through the switching system 14 and the base stations 15.

The server 13 determines the propagation time between the portable telephone 12 and the GPS satellite 11 thereby to determine the distance between the portable telephone 12 and the GPS satellite 11. The server 13 makes calculations for position detection using the distance thus calculated and thus detects the position of the portable telephone 12. The second pilot phase measurement is conducted in an auxiliary fashion for using the distance from the nearby base stations 15 as an alternative in a hypothetical case where the required number of the GPS signals 21 cannot be measured.

The basic concept of the position detection procedure has been described above. According to this embodiment, in addition to the basic concept described above, the base station information on the base station(s) having the same NID as the Serving NIS in the result of the initial pilot phase measurement transmitted by the portable telephone 12 is added to the GPS assist information 22 transmitted by the server 13.

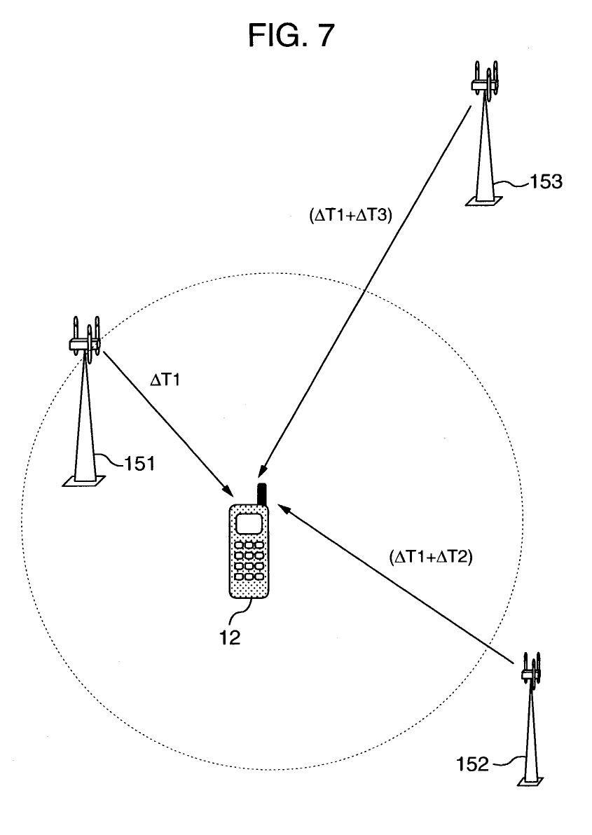

Now, the pilot phase measurement will be explained with reference to FIG. 7. By way of explanation, assume that three base stations (151, 152, 153) are involved. Nevertheless, there are generally four or more base stations involved.

In the portable telephone system of CDMA type, the reference time of the base stations are coincident with each other, and each base station transmits the same PN code repeatedly at the same rate. The PN codes transmitted by the base stations 151, 152, 153, however, are behind the reference time T0 by T1, T2, T3, respectively. Each base station also transmits the time shift (T1, T2, T3) of the nearby base stations together with the PN code, and therefore the portable telephone 12 can acquire the information on T1, T2, T3. In order to secure synchronism with the received PN code, the portable telephone 12 outputs the same PN code as transmitted from the base stations, at different timings, until it comes to be superposed on the PN code received. The portable telephone 12 is controlled to maintain the superposed timing thereby to keep in synchronism with the base stations.

In FIG. 7, assume that the operation of the portable telephone 12 is in synchronism with that of the base station 151. This station is called a reference base station. Normally, this station is identical with the Serving BS described above. In such a case, the propagation time of the radio wave between the base station 151 and the portable telephone 12 is given as ΔT1 (unknown number). The portable telephone 12 that has successfully established synchronism with the base station 151 outputs the PN code at a timing shifted by (T2−T1) based on the time shift of the signals received from the nearby base stations. Further, the portable telephone 12 outputs the PN code at each slightly different timing until it comes to be superposed on the PN code from the base station 152, and thus detects the signal from the base station 152. The signal detection is meant the observation of the large energy generated when two PN codes come to be superposed one on the other. At this time, the radio wave propagation time between the base station 152 and the portable telephone 12 is given as (ΔT1+ΔT2) (the parameter of the measurement result indicating the value ΔT2 is called PILOT_PN_PHASE). In similar fashion, the radio wave propagation time between the base station 153 and the portable telephone 12 is given as (ΔT1+ΔT3) (the value ΔT3 can be determined from the value of PILOT_PN_PHASE). Measuring the propagation time of the radio wave from communicable base stations in this way is defined as the pilot phase measurement.

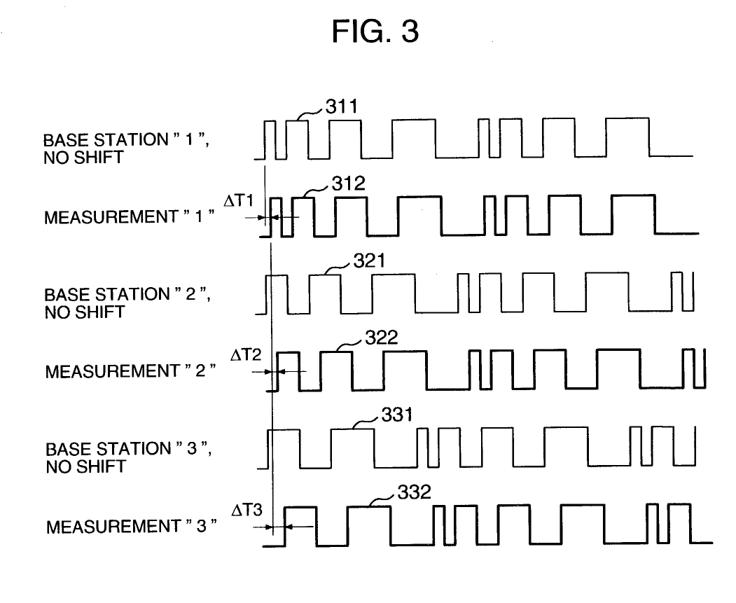

The operation described above is shown as a timing chart in FIG. 3. In FIG. 3, signal waveforms 311, 321, 331 represent the signals transmitted by the base stations, while signal waveforms 312, 322, 332 represent the signals received by the portable telephone 12. The pilot signal (measurement “1”) from the base station 151 constitutes a reference. The corresponding signal 321 of the base station 152 and the corresponding signal 331 of the base station 153 that should have the same timing as the reference timing of the reference pilot signal are predetermined.

With the pilot signal (measurement “1”) measured from the base station 151 as a reference, the time differences ΔT2 and ΔT3 from the measurement result 322 of the base station 152 and the measurement result 332 of the base station 153, respectively, are measured by the time difference detection means 204 of the portable telephone 12. In a method of this measurement for the base station 152, for example, the time count is started with the earlier one of the signal patterns corresponding to the measurement “1” and the measurement “2”, and stopped with the remaining another signal pattern. Assume that the accuracy of distance measurement is 3 m. The required accuracy of time measurement is 10 nsec (3 m divided by the velocity of light). This accuracy requires the clock frequency of 100 MHz, which is at the same level as the clock frequency of the microprocessors now in use and poses no special problem. Inherently, the measurement is desirably conducted for a plurality of base stations at the same time. Unless the moving speed of the portable telephone 12 is extremely high, however, the time difference of the pilot signals of a plurality of base stations can be measured sequentially at different timings. Suppose the moving speed of the portable telephone 12 is v m per second, and that the signals of five base stations are measured. To reduce the error of the distance measurement to not more than 3 m, the measurement for all the base stations is required to be completed within 3/v seconds. In the case where the portable telephone is moving at the rate of 100 km per hour, for example, the measurement for five base stations is required to be completed within 0.1 second.

Neither the position (latitude, longitude, altitude) of the portable telephone nor the radio wave propagation time (ΔT1 in the foregoing description) from the first-synchronized base station (the base station 151 in the foregoing description) to the portable telephone is known, and therefore four base stations are required to make calculations for detection of a three-dimensional position. This principle applies regardless of whether the position is measured using base stations or GPS satellites.

A method of position measurement according to this embodiment will be explained with reference to the flowchart of FIG. 1. In this method, the pilot signal of the first base station is used as a reference, and the distance between each base station and the portable telephone 12 is measured by switching the other base stations sequentially. This method can be implemented with the telephone signal synchronizing means now in use.

The first position measuring operation will be explained with reference to the flowchart of FIG. 1. The initial session of position detection is carried out in accordance with the basic position detection process utilizing the GPS (step 101). In the process, the aforementioned base station information added to the GPS assist information transmitted from the server 13, the result of the second pilot phase measurement carried out by the portable telephone 12 itself and the result of the position detection transmitted from the server 13 are recorded in the memory means 205 by the portable telephone 12. Also, in the case where the portable telephone 12 requests the server 13 to measure the position, the map information (image data of the map, contraction scale data, latitude/longitude/altitude data on the map) of the nearby areas where the portable telephone 12 that has requested the position measurement is located, in addition to the GPS assist information and the base station information, is transmitted from the server 13 to the portable telephone 12. The portable telephone 12 stores this map information in the memory means 205. The size of the area covered by the map information is arbitrary. In the case where the storage capacity of the memory means 205 is large, however, the map information over a sufficiently large area can be stored. Incidentally, it is assumed that the whole of the base station information on a multiplicity of nearby base stations (say, about ten stations) communicable with the portable telephone can be stored.

At the request of the user for a second position detection session, the portable telephone conducts the initial pilot phase measurement (step 102). The result of this initial pilot phase measurement is compared with the result of the initial second pilot phase measurement stored in the memory means 205. In the case where the base stations have the same NID as in the preceding session (YES in step 103), the number of the base stations acquired is checked. In the case where the number of base stations acquired is not less than four (YES in step 105), the base stations are checked whether they include the same base station as in the preceding session or not, and if the answer is affirmative (YES in step 107), the number of the base stations identical with those in the preceding session is checked to see whether it is four or more. In the case where there are four or more base stations identical to those in the preceding session (YES in step 109), the difference of the PILOT_PN_PHASE value, i.e. the change amount of the radio wave propagation time is determined from the two measurement results described above.

As a result, the distance by which the portable telephone has moved toward (or away from) a base station, as compared with the distance in the preceding measurement session, can be determined. By determining a plurality of (four or more) similar distances and making calculations using the base station position information (latitude, longitude, altitude) contained in the base station information described above, therefore, the present position can be detected. At the same time, the result of the second initial pilot phase measurement and the result of position detection are stored in the memory means 205.

Upon receipt of a request for the Nth position detection session, the portable telephone conducts the initial pilot phase measurement. The result of this initial pilot phase measurement is compared with the result of the (N−1)th initial pilot phase measurement thereby to detect the position for the Nth position detection session in a manner similar to the second position detection session. Then, the result of the current initial pilot phase measurement and the result of position detection are stored in the memory means 205.

In the second and subsequent position detection sessions which may be executed, the present position is indicated together with the map on the liquid crystal display of the information output means 211 using the map information first obtained by communication with the server. In the process, the present position is displayed either by fixing the map with respect to the past position indication or fixing a mark indication of the present position while scrolling the map.

Next, an explanation will be given of the second position measuring operation, i.e. the process for making comparison between the result of the preceding pilot phase measurement session and the result of the current pilot phase measurement session in step 107 of FIG. 1 in the absence of identical base stations.

In the case where the same base station is lacking as the result of comparison in step 107 (NO in step 107), the distance between each new base station covered by the current new measurement session and the portable telephone is determined based on the value of the result of the initial pilot phase measurement (PILOT_PN_PHASE) (step 108). A plurality of (four or more) distances between the base stations and the portable telephone are determined, and calculations are conducted using the base station position information described above thereby to detect the position of the portable telephone. The current values of the pilot phase measurement result and the position detection result are stored in the memory unit 205. In the second and subsequent sessions of position detection, the position is indicated in the same manner as in the first position measuring operation.

Next, an explanation will be given of the third position measuring operation, i.e., as shown in the step 109 of the flowchart of FIG. 1, the process executed in the case where comparison between the result of the preceding session of the pilot phase measurement and the result of the current session of the pilot phase measurement shows that one to three base stations are identical to those for the preceding session.

In the case where not more than three base stations are identical to those for the preceding session (NO in step 109), the first distance measuring operation is performed to determine the distance from each of the same base stations from which the radio wave is received as in the preceding session of pilot phase measurement. In the absence of the identical base stations, the distance is determined from a base station in the second distance measuring operation described above. A plurality of (or, four or more) distances between the base stations and the portable telephone are determined by the method employed in the first and second cases described above, and the calculations are made using the base station position information thereby to detect the position of the portable telephone. The result of the current session of pilot phase measurement and the result of the position detection are stored in the memory unit 205. In the second or subsequent position detection session, the position is indicated in the same manner as in the first case.

In this way, as shown in the flowchart of FIG. 1, the position information can be supplied to the user together with the map without receiving the GPS signal and without communication with the server in the second and subsequent sessions of position detection. In the second and subsequent position detection sessions, therefore, the data communication time with the server is not required and the labor is saved for receiving the GPS signal after obtaining the GPS assist information. As a result, depending on the algorithm for position calculations, the time consumed for displaying the current position information after being obtained can be remarkably reduced to about one fourth to one half of the corresponding time consumed in the prior art.

In the second and subsequent sessions of position detection, no communication charge accrues due to the communication with the server, and therefore the user can acquire the position information continuously without worrying about the charge. The initial pilot phase measurement conducted for each base station in the second and subsequent sessions of position detection requires only a short length of time. Therefore, even in the case where the speech operation and the initial pilot phase measurement are conducted by time division, the speech is not substantially affected, so that the position information can be obtained continuously even during speech.

In the position measuring operation shown in FIG. 1, the error of the calculations for position detection is assumed to be considerable in the case where the result of the preceding position detection session and the result of the current position detection session are distant from each other by N meters or longer (a distance of as long as 500 m detected in the position detecting operation performed at intervals of 5 seconds, for example, is seen clearly out of the correct position). Based on this idea, the position detecting operation may be performed using a GPS satellite in the case where this condition (not less than N m distant) is met. Further, in the case where five or more distances between the base stations and the portable telephone can be obtained, a plurality of calculations for position detection can be carried out and the average value of the calculation results may be used as the position detection result. Also, in the case where five or more distances between the base stations and the portable telephone can be obtained, calculations can be carried out effectively to determine the position excepting the aforementioned time measurement results low in reliability. A criterion for estimating the reliability of the time measurement result may be to determine whether the value Ec/Io or the difference with the preceding detection session is abnormal or not.

Next, the fourth and fifth position measuring operations will be explained with reference to the flowchart of FIG. 1. The fourth position measuring operation represents a case in which the user has moved to an area of a different NID, and the fifth position measuring operation a case in which not more than three base stations are acquired.

Upon receipt of a request for the second (or Nth) session of position detection, the portable telephone carries out the initial pilot phase measurement (step 102). In the case where the NID of the Serving BS contained in the result of the initial pilot phase measurement is different from the NID of the base station information stored in the memory means (NO in step 103), the position information of the base stations is required to be updated (step 104). In the case where the determination in step 103 is NO, therefore, the portable telephone 12 establishes a communication route with the server and requests the server to start the position measuring operation as described above while at the same time transmitting the result of the initial pilot phase measurement to the server. As a result, the portable telephone 12 receives the base station information together with the GPS assist information from the server and updates the base station information in the memory means. In other words, the position detection is restarted anew with the position detection with GPS in the fourth position measuring operation.

In the case where not more than three base stations are acquired (NO in step 105), on the other hand, the position measurement restarted with GPS as in the fourth position measuring operation (the fifth position measuring operation).

In the case where the storage capacity of the memory means 205 has a margin in the fourth or fifth position measuring operation, the past base station position information may be stored.

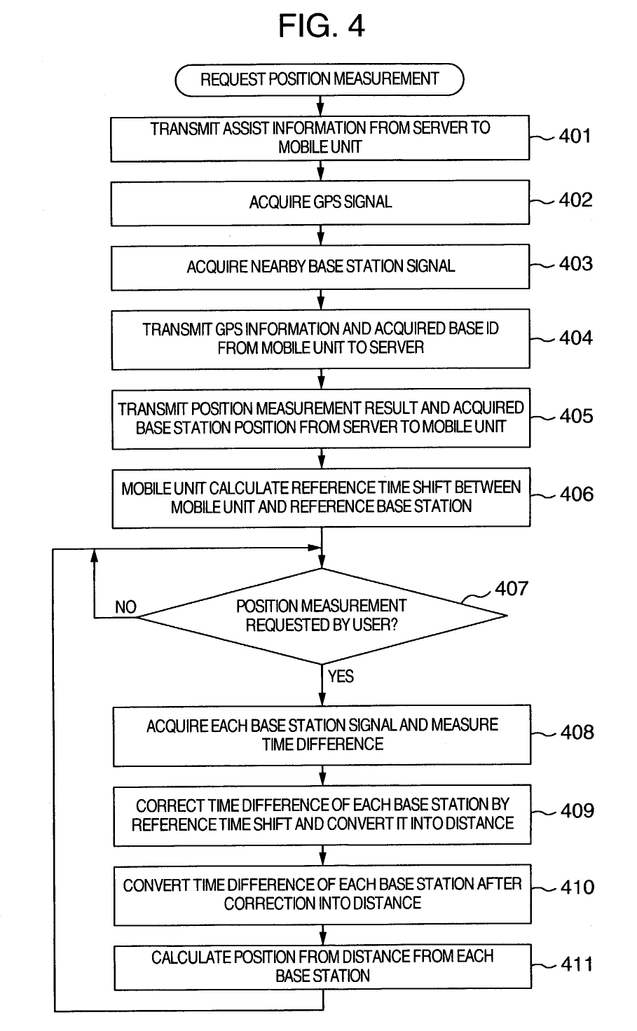

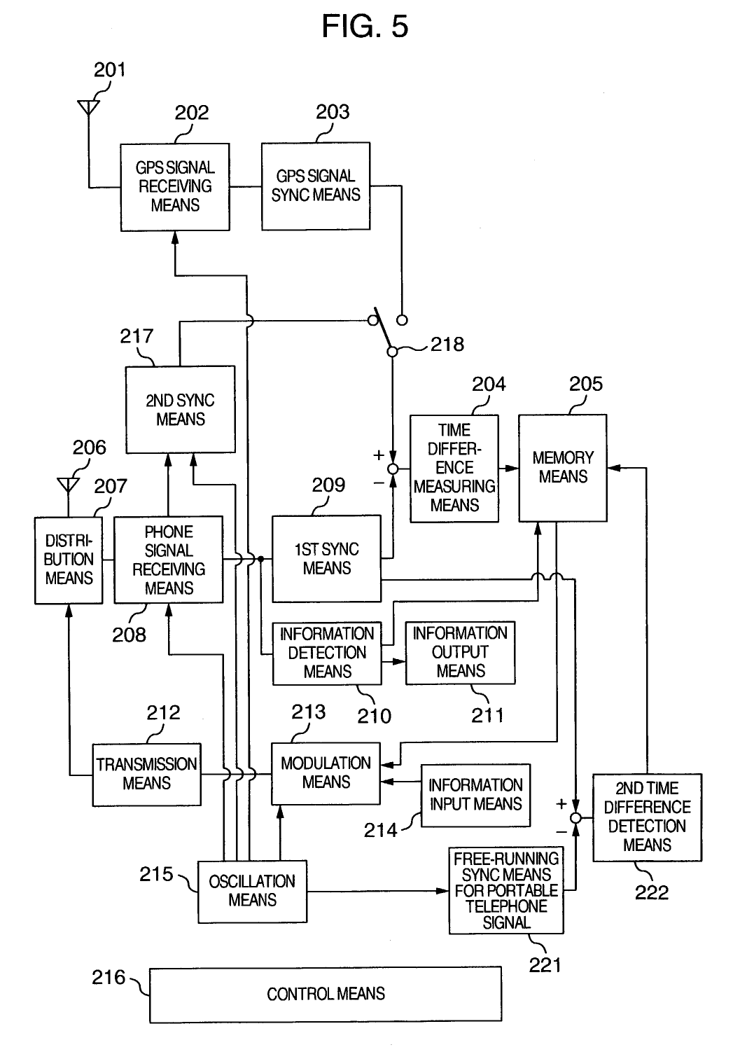

Next, a second embodiment of the invention will be explained with reference to FIGS. 4 and 5. According to this embodiment, the position measurement is made possible by base stations alone even in the case where only three base stations are acquired.

FIG. 5 is a block diagram showing a configuration of a portable telephone according to this embodiment. In FIG. 5, the component parts equivalent to those of the first embodiment shown in FIG. 2 are designated by the same reference numerals, respectively. In FIG. 5, numeral 221 designates a telephone signal free-running synchronization means and numeral 222 a time difference detection means.

The basic processing flow of this embodiment will be explained with reference to FIG. 4. In FIG. 4, the portable telephone 12 is described as a mobile unit.

First, the position is measured with GPS in response to a position measurement request (steps 401 to 405). This operation is similar to the corresponding one in the first embodiment. From the result of calculations of the position of the portable telephone 12 transmitted from the server and the position information of the reference base station already sent from the server, the portable telephone 12 calculates the distance between the reference base station and the portable telephone at the time of GPS measurement. This distance is divided by the velocity of light thereby to calculate the value ΔT1 in FIG. 3 constituting the radio wave propagation time between the reference base station and the portable telephone. From the timing shift amount ΔTp of the PN code of the portable telephone 12 synchronized with the pilot signal of the reference base station “1” and the radio wave propagation time described above, the reference time shift ΔTp1 between the reference base station and the portable telephone 12 is calculated as ΔTp1=ΔTp−ΔT1 (step 406).

Next, at the request of the user for position measurement (YES in step 407), the pilot signal of the base station to be measured is synchronized using the second synchronization means 217 shown in FIG. 5, and the time difference with the pilot signal of the reference base station is measured by the time difference detection means 204 (step 408). This time difference corresponds to ΔT2 of FIG. 3 for the base station “2” of FIG. 3, for example.

The distance between the base station 1″ and the portable telephone 12 is changed momently, and the value ΔT1 is not constant. In order to generate a signal of the same constant frequency as the pilot signal, therefore, a reference timing is generated in the portable telephone from the telephone signal free-running synchronization means 221. From the phase difference between the synchronization timing of the pilot signal of the reference base station output from the first synchronization means 209 and the reference timing generated by the telephone signal free-running synchronization means 21 described above, the variation δΔT1 of ΔT1 is kept detected by the second time difference detection means 222. Assuming the value ΔT2 at the time of GPS measurement is ΔT20, the variation of the radio wave propagation time for the base station “2” can be calculated as ΔT2−ΔT20+δΔT1. The same thing can be said of the base station “3” as the base station “2” (step 409). By multiplying this variation of the radio wave propagation time by the velocity of light, the change amount of the distance between each base station and the portable telephone 12 from the time point of GPS measurement can be calculated. This change amount is added to the distance between each base station and the portable telephone 12 at the time of GPS measurement thereby to calculate the distance between the particular base station and the portable telephone 12 at the particular time point (step 410). In this way, the distance with the three base stations can be calculated, and therefore the position of the portable telephone 12 at a particular time point can be calculated by the position detection calculations (step 411).

In the second and subsequent sessions of position detection, the position is indicated in the same manner as in the first to third position measuring operations according to the first embodiment, and the present position is indicated on the map using the map information acquired from the server at the time of the initial GPS measurement.

After the position could be successfully measured with high accuracy using a GPS satellite, the distance over which the radio wave propagates from each base station to the portable telephone can be compared with the actual distance between the portable telephone and each base station which is already known. In the case where the distance over which the radio wave propagates is considerably different from the actual distance, it can be determined that the radio wave that has reached the portable telephone from each base station is reflected midway. In view of this, the accuracy of position measurement can be improved by making calculations for several hypothetical cases, or for example, by employing a case most suitable for two measurement sessions, without converting the change of the propagation distance from a particular base station directly into the change in distance. In the case where four or more base stations are communicable, on the other hand, the accuracy of position measurement can be improved by eliminating the use in calculations of the data of a base station involving a large difference between the actual distance and the propagation distance or by reducing the weight thereof.

In a case corresponding to the second position measuring operation according to the first embodiment, the timing shift of the portable telephone is already detected in the first measurement session. As far as the three-dimensional position information of each base station can be received by the portable telephone, therefore, the radio wave propagation time from a base station from which signals are newly received can also be measured. As a result, the distance from all stations can be determined, and as in the first case, the position measurement is possible as long as the signals from the three base stations can be received.

Also in a case corresponding to the third position measuring operation according to the first embodiment, like in the case described above, the position measurement is possible as far as signals can be received from three base stations.

According to this embodiment, like in the first embodiment described above, the second and subsequent sessions of position detection can be performed without consuming the data communication time with the server and the receiving the GPS signal after acquisition of the GPS assist information. Therefore, the time before the present position information is acquired and indicated is expected be shortened remarkably as compared with the corresponding time in the prior art. Also, in the second and subsequent sessions of position detection, no communication charge due to the communication with the server accrues, and therefore the user can continue to acquire the position information without worrying about the charge. Further, the initial pilot phase measurement for each base station in the second and subsequent sessions of position detection requires only a short length of time. Even in the case where the speech operation and the initial pilot phase measurement are conducted by time division, therefore, the speech is not substantially affected for practical purposes. Thus, the position information can continue to be acquired even during the speech. Specifically, the conventional portable telephone capable of GPS measurement which is used by switching a common circuit between GPS and the portable telephone, and therefore poses the problem that the telephoning operation is impossible during position measurement. According to this invention, in contrast, the communication is conducted exclusively with base stations after the initial GPS measurement, and therefore, the continuous position measurement at intervals of a predetermined time interval is possible even during radio speech simply by improving the processing ability of the portable telephone.

From the foregoing description, it is obvious that according to this invention, the user can acquire the position information continuously without communicating with the server substantially or without worrying about the communication charge. Also, the time for position detection in the second and subsequent sessions can be remarkably shortened and the position information can be acquired even during the speech. The conveniences of the user can thus be greatly enhanced.

Many different embodiments of the present invention may be constructed without departing from the spirit and scope of the invention. It should be understood that the present invention is not limited to the specific embodiments described in this specification. To the contrary, the present invention is intended to cover various modifications and equivalent arrangements included within the spirit and scope of the claims.

1. A position detection system comprising:
a portable terminal capable of receiving a GPS signal from a GPS satellite;
a base station which carries out communication with said portable terminal; and
a server which receives said GPS signal from said portable terminal through said base station and detecting the position of said portable terminal;
wherein said portable terminal includes:
a transmitter which transmits said GPS signal to said server;
a position acquisition unit which acquires the position information of said portable terminal calculated by said server;
a measurement unit which measures the radio wave propagation time from said base station; and
a position calculator which calculates the position of said portable terminal by use of the radio wave propagation time measured by said measurement unit, said position information acquired by said position acquisition unit and the base station position information indicating the position of said base station.

2. A position detection system according to claim 1,
wherein said position acquisition unit acquires map information together with said position information.

3. A portable terminal capable of communication with a server through a base station, comprising:
a GPS receiver capable of receiving a GPS signal from a GPS satellite;
a transmitter which transmits said GPS signal to said server;
a position acquisition unit which acquires the position information of said portable terminal calculated by said server;
a measurement unit which measures the radio wave propagation time from said base station; and
a position calculator for calculating the position of said portable terminal by use of the radio wave propagation time measured by said measurement unit, said position information acquired by said position acquisition unit and the base station position information indicating the position of said base station.

4. A portable terminal according to claim 3,
wherein said base station position information is transmitted from said server.

5. A portable terminal according to claim 3, further comprising a memory unit for storing said base station position information and the position information acquired by said position acquisition unit.

6. A portable terminal according to claim 3,
wherein said position acquisition unit acquires map information together with said position information.

7. A portable terminal according to claim 6, further comprising a display unit which displays a map in accordance with said position information,
wherein said display unit displays, in superposed relation with said map, the position calculated by said position calculation unit.

8. A portable terminal according to claim 3,
wherein the initial session of position detection is such that the position information calculated by said server is acquired by said position acquisition unit, and the second and subsequent sessions of position detection are such that the position is calculated by said position calculation unit.

9. A portable terminal capable of communication with a server through a base station, comprising:
a GPS receiver capable of receiving a GPS signal from a GPS satellite;
transmission means for transmitting said GPS signal to said server;
a position acquisition unit for acquiring the position information of said portable terminal calculated by said server;
a measurement unit for measuring the radio wave propagation time from said base station; and
a position calculator for calculating the position of said portable terminal by use of the radio wave propagation time measured by said measurement unit, said position information acquired by said position acquisition unit and the base station position information indicating the position of said base station.
